(19) United States
(12) Patent Application Publication
(10) Pub. No.: US 2024/0005255 A1
(43) Pub. Date: Jan. 4, 2024

(54) VELOCITY OPTIMIZER USING MACHINE LEARNING

(71) Applicant: Dell Products, L.P., Round Rock, TX (US)

(72) Inventors: Mahuya Ghosh, Telangana (IN); Rajendra Kulkarni, Bangalore (IN)

(73) Assignee: Dell Products, L.P., Round Rock, TX (US)

(21) Appl. No.: 17/810,114

(22) Filed: Jun. 30, 2022

(51) Int. Cl. G06Q 10/06

(52) U.S. Cl. CPC G06Q 10/06398; G06Q 10/063112

(57) ABSTRACT

A method comprising: calculating a velocity threshold for an entity, the entity including an individual worker or a team of workers; calculating a velocity for the entity by classifying a first signature corresponding to the entity with a first machine learning (M/L) classifier, the velocity being a metric that measures a current productivity of the entity; detecting whether the velocity meets the velocity threshold; and outputting an alert when the velocity meets the velocity threshold.

### BACKGROUND

Project management software is a type of software manages the distribution of work among software developers on a project and monitors the developers' progress. Specifically, project management software may be used to plan, track, and organize the workload that is placed on each developer on the market. In doing so, the project management software may help developers to stay on track with project timelines, milestones, and dependencies. Some of the more popular software management software suites that are available on the market include Jira™, Microsoft Project™, and Trello™.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided comprising: calculating a velocity threshold for an entity, the entity including an individual worker or a team of workers; calculating a velocity for the entity by classifying a first signature corresponding to the entity with a first machine learning (M/L) classifier, the velocity being a metric that measures a current productivity of the entity; detecting whether the velocity meets the velocity threshold; and outputting an alert when the velocity meets the velocity threshold.

According to aspects of the disclosure, a system is provided comprising: a memory; and at least one processor operatively coupled to the memory, the at least one processor being configured to perform the operations of: calculating a velocity threshold for an entity, the entity including an individual worker or a team of workers; calculating a velocity for the entity by classifying a first signature corresponding to the entity with a first machine learning (M/L) classifier, the velocity being a metric that measures a current productivity of the entity; detecting whether the velocity meets the velocity threshold; and outputting an alert when the meets the velocity threshold.

According to aspects of the disclosure, a non-transitory computer-readable medium is provided that stores one or more processor-executable instructions, which, when executed by at least one processor, cause the at least one processor to perform the operations of: calculating a velocity threshold for an entity, the entity including an individual worker or a team of workers; calculating a velocity for the entity by classifying a first signature corresponding to the entity with a first machine learning (M/L) classifier, the velocity being a metric that measures a current productivity of the entity; detecting whether the velocity meets the velocity threshold; and outputting an alert when the velocity meets the velocity threshold.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a flowchart of an example of a process, according to aspects of the disclosure.

FIG. 2 is a diagram of an example of a computing device, according to aspects of the disclosure;

FIG. 3 is a diagram of an example of a user interface, according to aspects of the disclosure;

FIG. 4 is a diagram of an example of a user interface, according to aspects of the disclosure;

FIG. 5A is a diagram of an example of a user interface, according to aspects of the disclosure;

FIG. 5B is a diagram of an example of a user interface, according to aspects of the disclosure;

FIG. 6A is a diagram of an example of a user interface, according to aspects of the disclosure;

FIG. 6B is a diagram of an example of a user interface, according to aspects of the disclosure;

FIG. 6C is a diagram of an example of a user interface, according to aspects of the disclosure;

FIG. 7A is a diagram of an example of a user interface, according to aspects of the disclosure;

FIG. 7B is a flowchart of an example of a process, according to aspects of the disclosure;

FIG. 8A is a flowchart of an example of a process, according to aspects of the disclosure;

FIG. 8B is a flowchart of an example of a process, according to aspects of the disclosure;

FIG. 8C is a flowchart of an example of a process, according to aspects of the disclosure;

FIG. 8D is a flowchart of an example of a process, according to aspects of the disclosure;

FIG. 8E is a flowchart of an example of a process, according to aspects of the disclosure;

FIG. 9 is a flowchart of an example of a process, according to aspects of the disclosure;

FIG. 10 is a flowchart of an example of a process, according to aspects of the disclosure; and

FIG. 11 is a flowchart of an example of a velocity optimizer, according to aspects of the disclosure.

### DETAILED DESCRIPTION

In software development, work may be managed in sprints. A sprint may be a period, such as two weeks, in which a certain amount of work needs to be completed by a team of developers. This amount of work is herein referred to as “a sprint workload.” A sprint workload is generally divided into tasks.

In another aspect, a sprint workload may include a plurality of stories. Each story may include information about a task which would assist developers in sizing the task. In other words, each story may be viewed as a representation of a respective task at the project management level. For this reason, throughout the disclosure, the terms “story” and “task” may be used interchangeably.

Each story in a sprint workload may be assigned a certain number of work points. The number of work points that are assigned to a story are also referred to as “a size” of the story. The number of work points that are given to a story may measure the amount of work (or time) that is needed to complete the story's corresponding task, and they also may be used to monitor developer productivity. The work points that are assigned to a story can be used to quantify the amount of work that is performed by a developer. Throughout the disclosure, the terms “work points” and “story points” may be used interchangeably.

When a sprint workload is divided among the developers on a team, each developer is assigned one or more stories from the workload. The assignment of stories to different developers can be performed based on the stories' respective sizes as well as other information.

According to aspects of the disclosure, a velocity optimizer is provided that can be used to streamline project management in the software development fields, as well as other fields. The velocity optimizer may automatically assign story sizes to different stories in a sprint workload based on sprint goals. In some implementations, the assignment may be performed based on a configuration score. In addition, the velocity optimizer may use machine learning (M/L) to automatically assign stories to different developers on a team. Furthermore, the velocity optimizer may use M/L to determine the velocity of a developer or a team of developers and use the determined velocity to monitor productivity. The velocity optimizer may detect a decline in the velocity of a developer or a team and issue an alert that is aimed at reducing (or turning around) the velocity decline.

The velocity of an entity may be a measure of the productivity of that entity. For example, the velocity of a developer may be a measure of the productivity of the developer, and the velocity of a team of developers may be a measure of the productivity of the entire team. The exact relationship between velocity and the information used to determine the velocity is specified by a training data set. The training data set may include a plurality of training items. Each training item may include a signature encoding information regarding the entity, and a label that is generated by a human expert which identifies a velocity that corresponds to the signature. The training data set may be used to train a classifier, which in turn can classify different (un-labeled) signatures into categories that correspond to different velocities.

There are many project management tools that are available on the market which can be used for the assignment of stories to different developers on a team. These tools use rule-based logic to monitor current sprint work as well as report on sprint velocities. However, few, if any, of these tools are equipped to perform intelligent correlation between story size and assigning work to the best developer for the job. Furthermore, few, if any, of these tools have any predictive or preventative capabilities for addressing velocity decline in a proactive way.

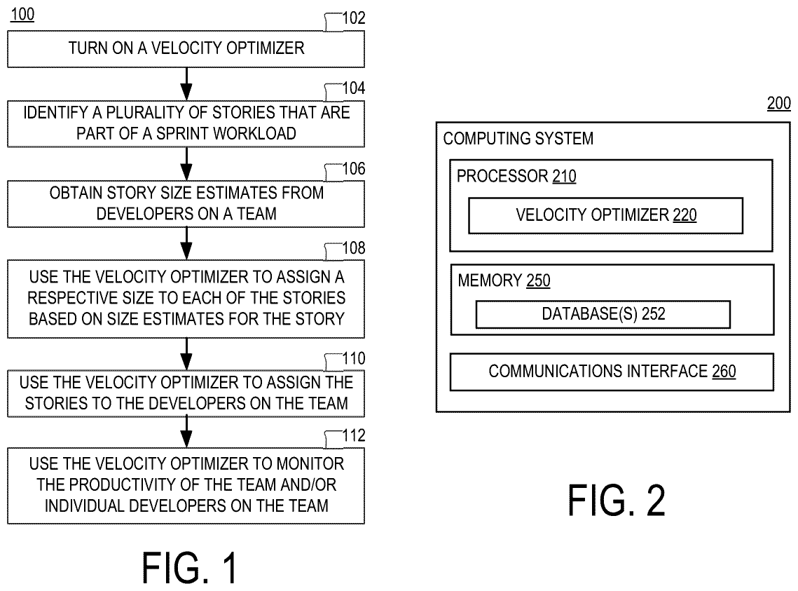

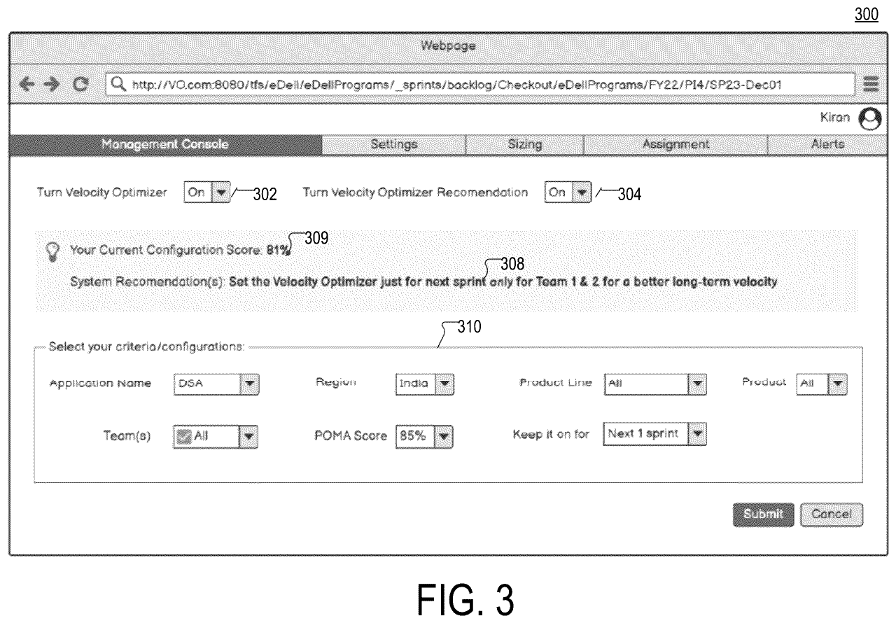

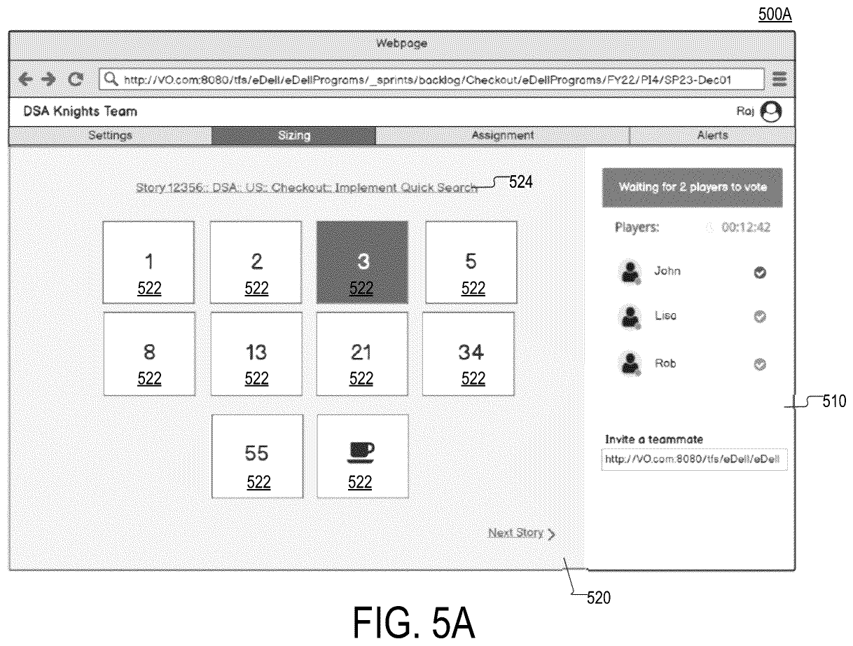

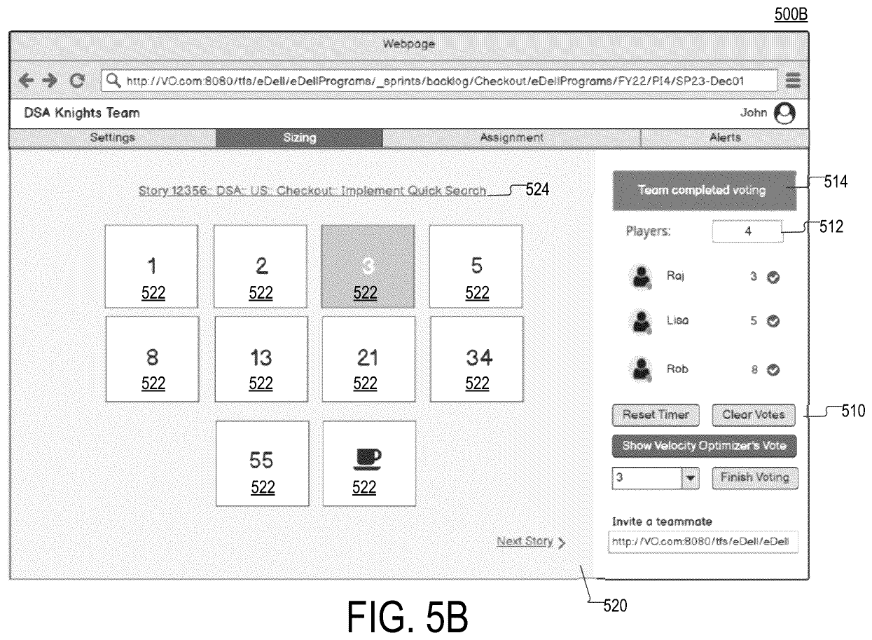

FIG. 1 is a flowchart of a process 100, which illustrates one possible use case for a velocity optimizer 220 (shown in FIG. 2). At step 102, the velocity optimizer 220 is turned on. In some implementations, the velocity optimizer 220 may be turned on based on a system recommendation, as discussed further below with respect to FIG. 3. At step 104, a plurality of stories that are part of a workload is identified. At step 106, size estimates for the stories are obtained from different developers on a team. The size estimates may be obtained by using screens 500A-B, which are discussed further below with respect to FIGS. 5A-B. At step 108, the velocity optimizer 220 is used to assign a story size to each of the developers on the team. The assignment is performed based on the size estimates (obtained at step 106). At step 110, each of the stories is assigned to a respective one of the developers by the velocity optimizer 220. At step 112, the velocity optimizer 220 monitors the velocities of different developers on the team and issues an alert if the velocity of any of the developers is insufficient to realize a specified productivity goal.

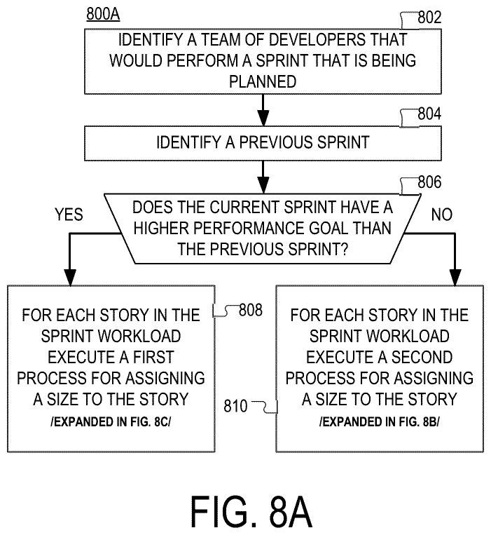

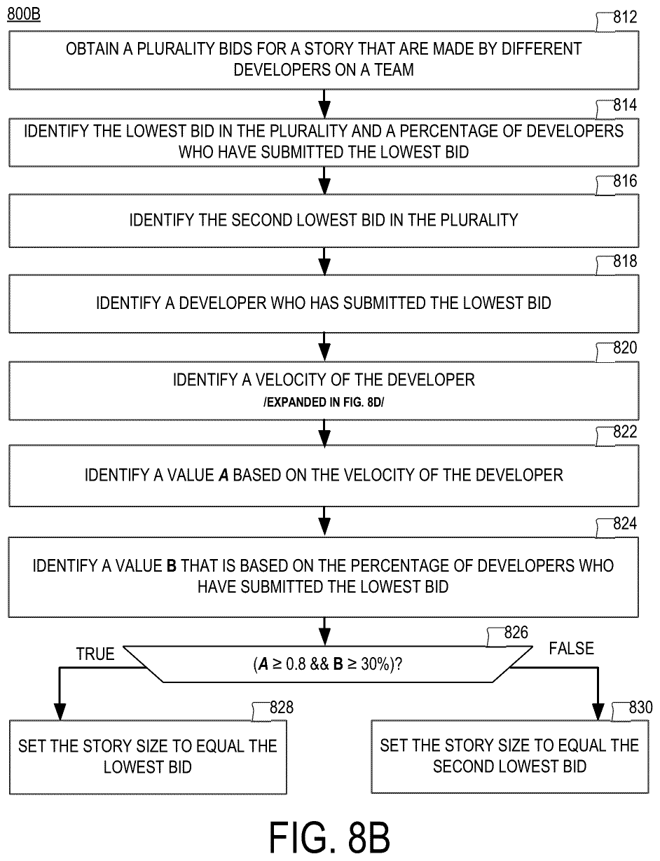

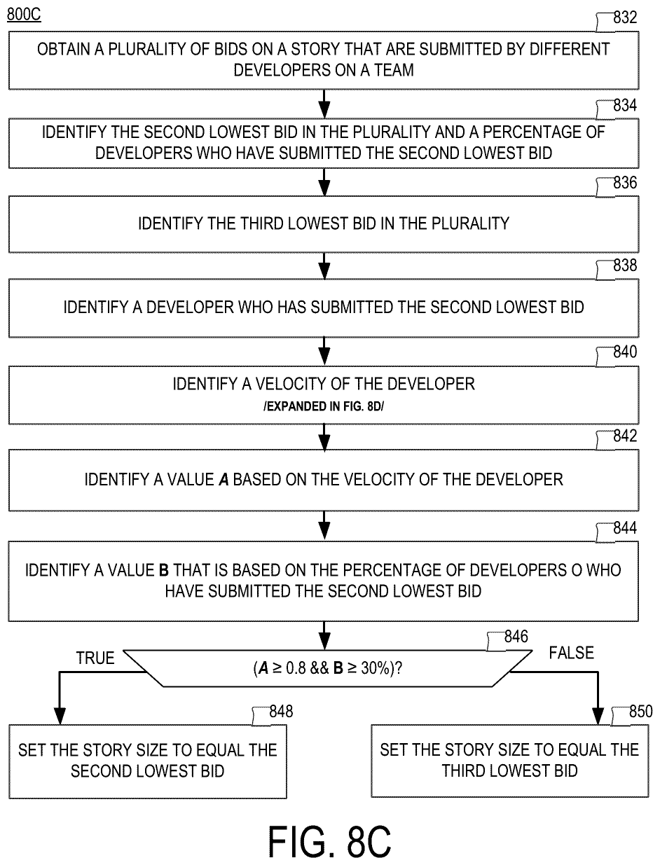

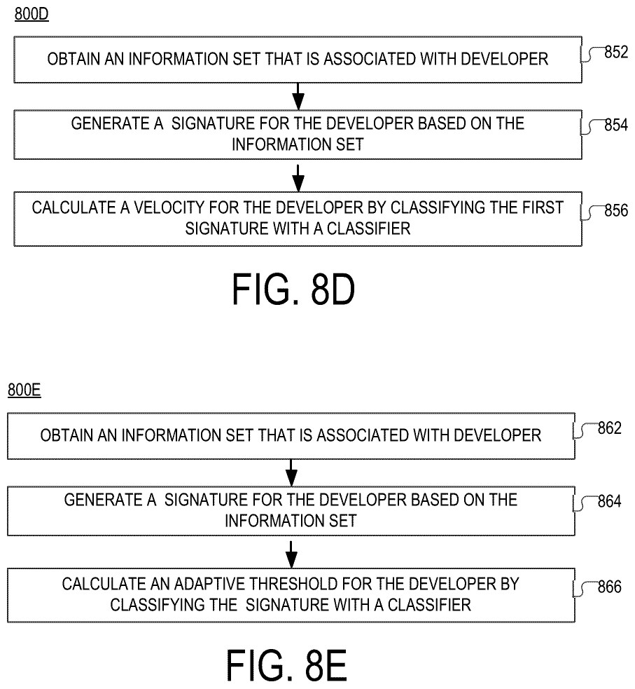

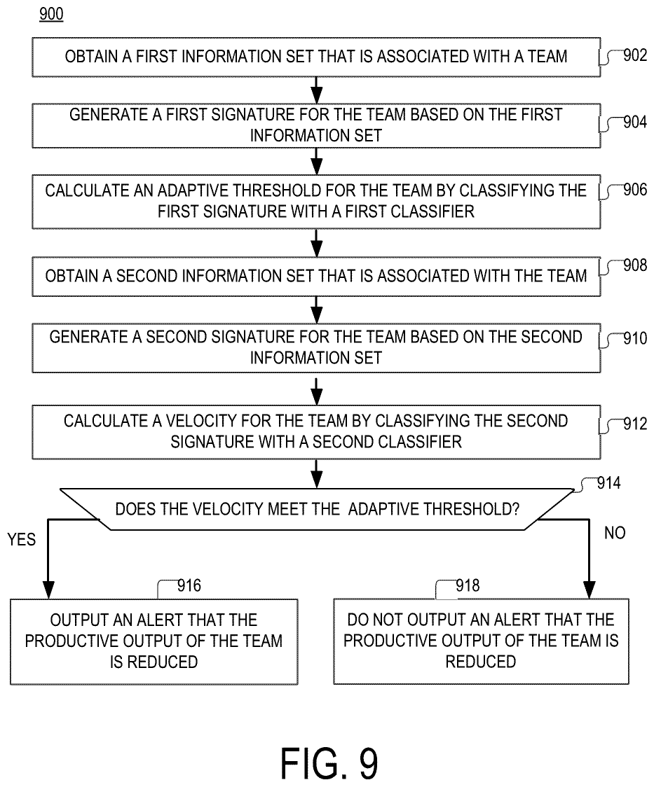

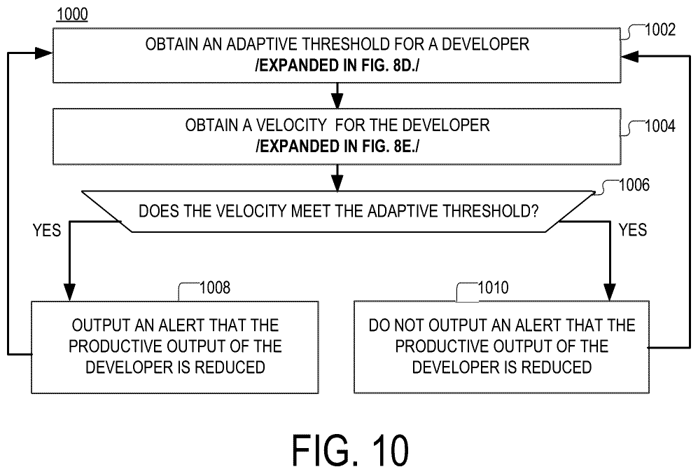

FIG. 2 is a diagram of a computing system 200, according to aspects of the disclosure. The computing system may include a processor 210, a memory 250, and a communications interface 260. The processor 210 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The processor 210 is configured to execute the velocity optimizer 220. Although the velocity optimizer is implemented in software in the present example, alternative implementations are possible in which the velocity optimizer 220 is implemented in hardware or as a combination of software and hardware. The memory 250 may include any suitable type of volatile and/or non-volatile memory. The memory 250 may be configured to store one or more databases 252. The databases 252 may be configured to store the information used by the velocity optimizer to generate the signatures discussed with respect to FIGS. 8D-E, 9, and 11. In addition, the databases 252 may store records that identify the current capacity of developers on a team. In some implementations, the memory 250 may include one or more of a random-access memory (RAM), a dynamic random memory (DRAM), a flash memory, a hard drive (HD), a solid-state drive (SSD), a network accessible storage (NAS), and or any other suitable type of memory device. The communications interface 260 may include any suitable type of communications interface, such as one or more Ethernet adapters, one or more Wi-Fi adapters (e.g., 802.1414 adapters), and one or more Long-Term Evolution (LTE) adapters, for example.

FIG. 3 is a diagram of an example of a screen 300, according to aspects of the disclosure. The screen 300 may be part of the user interface of the velocity optimizer 220. The screen 300 may include an input component 302 for turning the velocity optimizer 220 on and off. In addition, the screen 300 may include an input component 304 for turning on and off a recommendation feature of the velocity optimizer 220. In addition, the screen 300 may include a portion 310 where the user can input various configuration settings of the velocity optimizer 220, such as the name of an application that is associated with a sprint, the region where the developers who would conduct the sprint a located, product line associated with the sprint, products associated with the sprint, an identifier of the team that would conduct the sprint, a desired minimum maturity score of a development of the team for building and shipping out products to the market, and duration for which the velocity optimizer is desired to remain activated. The desired minimum maturity score may be assigned by human experts through auditing based on the following dimensions: vision (whether the team has a clear product vision), roadmap (whether the team has a clear roadmap), whether the team has clearly defined user or business key performance indicators (KPIs), whether the team meets with stakeholders periodically, whether the team has a clearly defined backlog, whether the team has quality measures in place that ensure 25% defect reduction, whether the team makes data-driven decisions, etc.

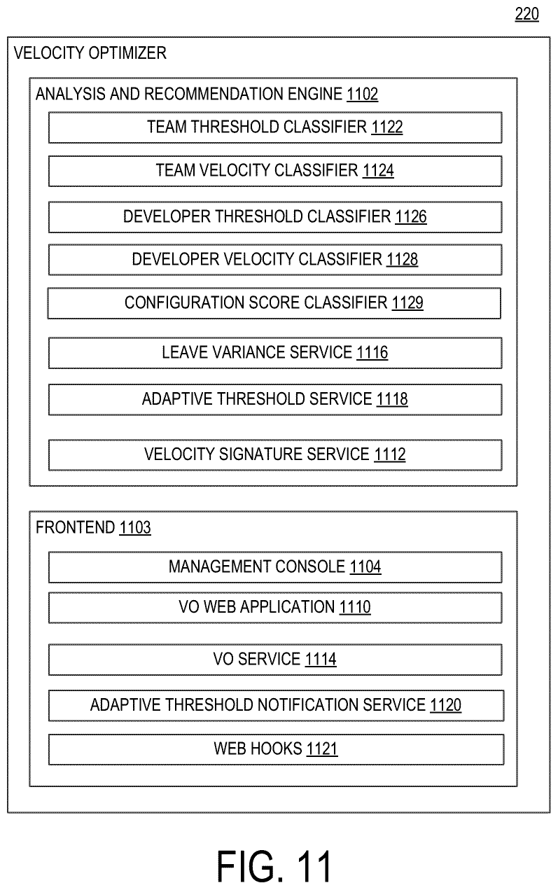

The recommendation feature of the velocity optimizer 220 includes a feature whereby the velocity optimizer 220 recommends respective sizes for different stories in a sprint workload. The screen 300 may include an indication of a configuration score 309 and an indication of a system recommendation 308 that is generated by the velocity optimizer 220 based on the configuration score. In some implementations, the recommendation may be output when the configuration score of the team is below a predetermined threshold value. The configuration score 309 may be generated by: (i) obtaining an information set, (ii) generating a signature based on the information set, and (iii) calculating the configuration score by classifying the signature into one of a plurality of categories, wherein each category corresponds to a different configuration score. The obtained information set may identify one or more of a team ID, seasonality, velocity trend (e.g., an indication of whether the velocity for a team is increasing or decreasing), leave variance of the developers in the team, attrition of developers in the team, management changes in the team, changes in team structure. In some implementations, the information set may include any of the information items that are specified by portion 310 the screen 300. In some implementations, any of the items in the information set may identify one or more of (i) a characteristic of a team that is about to be assigned a sprint workload, (ii) characteristic of a product whose code is going to be developed (e.g., created or changed) in the sprint, and/or (iii) a characteristic of a time period when the sprint is going to be conducted. The signature may be a number (and/or an alphanumerical string) that encodes each of the data items in the obtained information set. The classifier used to classify the signature may be the same or similar to the classifier 1129, which is discussed further below with respect to FIG. 11. FIG. 3, illustrates another notable aspect of the velocity optimizer, whereby the velocity optimizer 220 provides a recommendation as to whether to use the velocity optimizer to assign story sizes or assign stories for a certain team, application, product, or product line. This may ensure a long-term success of product teams in a sustainable manner.

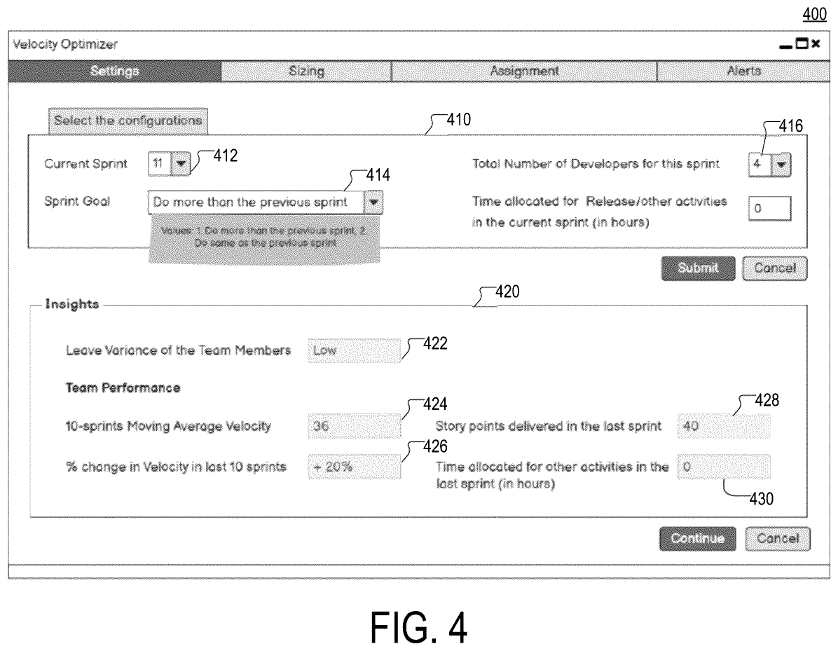

FIG. 4 is a diagram of an example of a screen 400, according to aspects of the disclosure. The screen 400 may be part of the user interface of the velocity optimizer 220. The screen 400 may include portions 410 and portions 420. Portion 410 includes input components for specifying various configuration settings of a new sprint. Specifically, portion 410 includes input component 412 for specifying an identifier of the new sprint, an input component 414 for specifying a goal for the new sprint, and an input component 416 for specifying the number of developers on the team that would perform the sprint.

In some implementations, the input component 414 may enable the user to specify whether the user desires the new sprint to have the same goal as a previous sprint or a greater goal. For example, the goal for a sprint may be measured by the total number of work points that are assigned to the stories in the sprint workload. In this case, a greater goal for a sprint may entail the team of developers performing a greater amount of work for the new sprint than it did for the previous sprint. As another example, the goal for a sprint may be measured in work points per unit time. In this case, a greater goal for a sprint may entail the team of developers performing the same amount of work as in the previous sprint, but in a shorter amount of time.

Portion 420 may provide information about the team of developers that is designated to perform the new sprint. For example, portion 420 may identify the leave variance 422 of the team, an indication of the average velocity 424 of the team over the past 10 sprints, an indication of the percent change 426 of the velocity of the team over the past 10 sprints, an indication of the number 428 of work points that were delivered by the team in the last sprint that is performed by the team, and an indication of the time 430 that was allocated to other activities in the last sprint. The leave variance for a developer may be calculated based on the number of days in which a developer has been unavailable during each of a plurality of sprints. The leave variance for a team may be calculated based on the number of days which developers on the teams have been unavailable during each of a plurality of sprints. Although throughout the disclosure leave variance is used to determine velocities and/or adaptive thresholds, it will be understood any measure of the propensity of a developer to take leaves (e.g., days off or sick days) during a sprint (or the propensity of the developers on a team to take leaves) can be used instead, such as an average number of leaves, etc.

FIG. 5A is a diagram of an example of a screen 500A, according to aspects of the disclosure. The screen 500A may be displayed on devices that have non-administrative privileges. The screen 500A may be used by a developer to submit a size for a story that is identified by an identifier 524. The submitted size may be a manifestation of the developer's personal judgment on how much work is involved in the story or the time it takes to perform the work. Under the nomenclature of the present disclosure, the submission of a size (or work points) by a developer is also referred to as “placing a bid” on the story.

The screen 500A includes a portion 520 having buttons 522 and the identifier 524. Each of the buttons 522 is associated with a different number of work points. The user may submit, to the velocity optimizer 220, a desired number of work points for the story (identified by identifier 524) by pressing one of the buttons 522 which corresponds to the desired number of work points. Portion 510 of the screen 500A may provide additional information about the bidding process for the story (identified by identifier 524). For example, portion 510 may identify each of the developers on a team of developers that is assigned to work on a sprint, which the story is part of. Additionally or alternatively, portion 510 may indicate whether each of the developers on the team has submitted a desired number of work points for the story (identified by identifier 524). Additionally or alternatively, portion 510 may include a timer showing how much time is left to submit a work point bid for the story (identified by identifier 524) before the bidding is closed.

FIG. 5B is a diagram of an example of a screen 500B, according to aspects of the disclosure. The screen 500B may be part of the user interface of the velocity optimizer 220. The screen 500B may be displayed on devices that have administrative privileges. The screen 500B may be nearly identical to the screen 500A. However, portion 510 of the screen 500B may further include a button for resetting the timer that counts the time that is remaining to submit a work point bid, a button for clearing the votes that have been cast, and a button for ending the bidding on the story (identified by identifier 524). Furthermore, portion 510 of the screen 500B may include a button, which when pressed, causes: (i) the velocity optimizer to assign work points to the story, and (ii) the screen 500B to display an indication of the number of work points that have been assigned by the velocity optimizer 220.

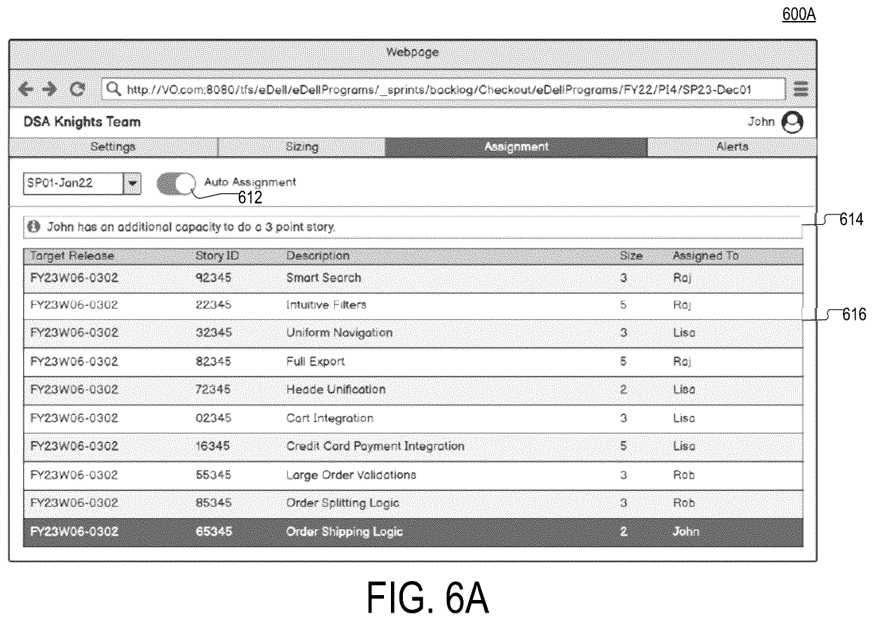

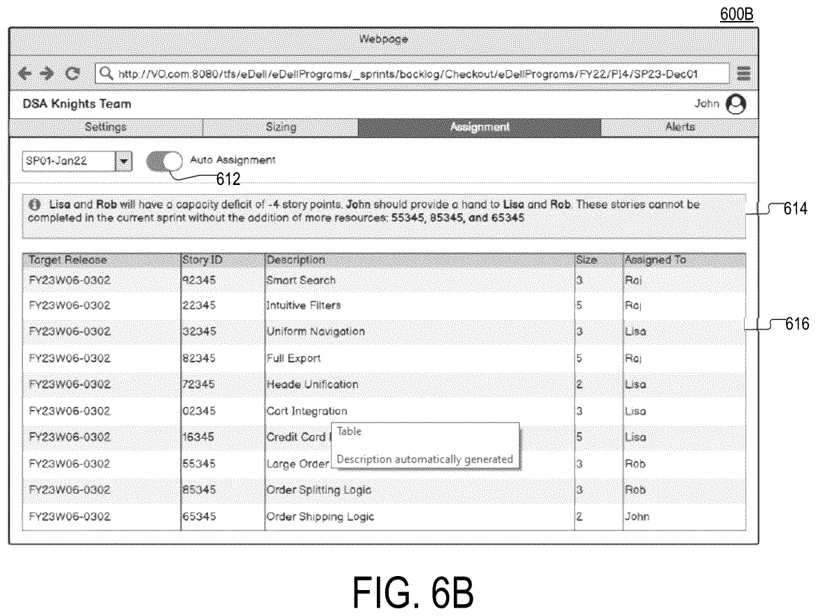

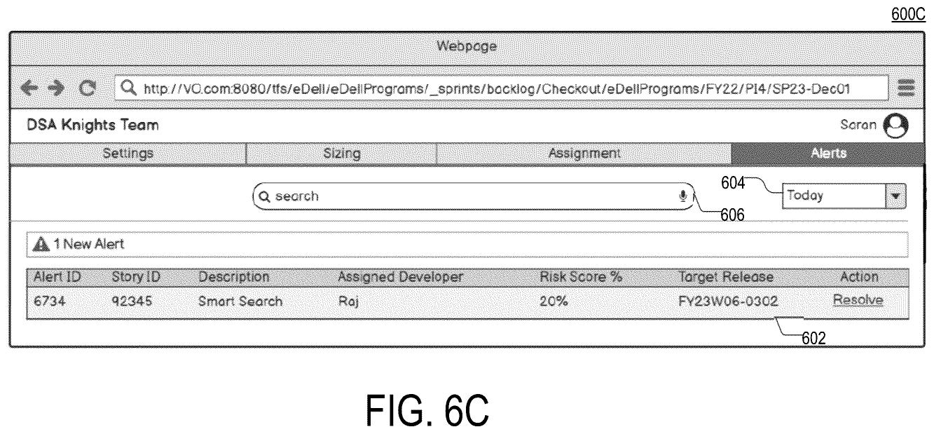

FIG. 6A is a diagram of a screen 600A, according to aspects of the disclosure. The screen 600A may include a list 616 of story assignments that is generated by the velocity optimizer 220 in response to a slider 612 being turned on. The stories whose assignments are shown in the list 616 form the workload (entire or partial) for a sprint that will be performed by a team of developers. The list 616 may include a plurality of rows. Each row may be associated with a different story (hereinafter “the row's corresponding story”). Each row may include: (1) an indication of the target release of which the row's corresponding story is part, (ii) a numerical identifier of the row's corresponding story, (iii) the name of the row's corresponding story, (iv) an indication of the size that is assigned to the row's corresponding story by the velocity optimizer 220, and (v) the name of the developer to whom the row's corresponding story has been assigned by the velocity optimizer 220. In addition, the screen 600A may include a portion 614 which identifies one or more developers who have the capacity to perform additional work during the sprint.

FIG. 6B is a diagram of a screen 600B, according to aspects of the disclosure. The screen 600B may be part of the user interface of the velocity optimizer 220. The screen 600B is identical to the screen 600A. However, in the example of FIG. 6B, portion 614 identifies one or more developers who have a capacity deficit.

FIG. 6C is a diagram of a screen 600C for displaying alerts, according to aspects of the disclosure. In the present example, the screen shows an alert 602. The alert is associated with a particular developer. The alert 602 is an indication that the velocity of the developer has fallen below a velocity threshold (or is approaching the velocity threshold). As indicated, the alert 602 may include an alert ID, a name or other identifier of the particular developer, an ID of a story that is assigned to the developer, a description or name of the story, an ID of a release date for the story, and an indication of a risk score. The risk score may be based on a distance between a velocity of the developer and an adaptive threshold for the developer. The distance may be calculated by subtracting the velocity from the threshold. For example, any negative distance may result in a 100% risk score. When the distance is positive, the risk score may be proportional to the distance (e.g., the smaller than the absolute value of the distance, the greater the risk score). The distance between a velocity and an adaptive threshold is discussed further below with respect to FIG. 10. Although in the example of FIG. 6C the screen 600C includes only one alert, it will be understood that the screen 600C may be configured to display any number of alerts. In some implementations, the screen 600C may be provided with an interface 604 for filtering UI components. Furthermore, in some implementations, the screen 600C may be provided with an interface 606 for searching through all (or some) of the alerts that have been issued in the past.

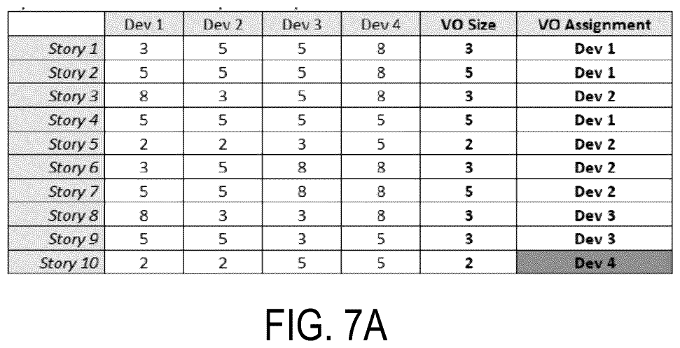

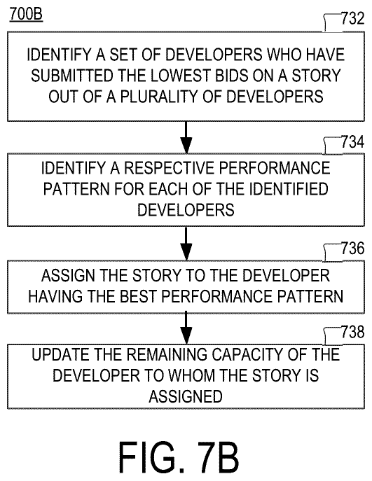

FIG. 7A shows a table that illustrates aspects of the operation of the velocity optimizer 220. Each row in the table corresponds to a different story (hereinafter “the row's corresponding story”). The stories listed in the table constitute an entire (or partial) workload of a sprint. The sprint is performed by a team of developers including a developer Dev 1, a developer Dev 2, a developer Dev 3, and a developer Dev 4. Each row in the table identifies: (i) the size submitted for the row's corresponding story by Dev 1, (ii) the size submitted for the row's corresponding story by Dev 2, (iii) the size submitted for the row's corresponding story by Dev 3, (iv) the size submitted for the row's corresponding story by Dev 4, (v) the size assigned to the row's corresponding story by the velocity optimizer 220, and (iv) the developer to whom the story is assigned by the velocity optimizer 220.

In some respects 6A-7 illustrate two of the main functions of the velocity optimizer 220—namely, (i) assigning a size (e.g., an optimal size) to a story, and (ii) assigning the story to a developer (e.g., a developer who can complete it in the least amount of time while maintaining acceptable quality). In some implementations, each of these functions may be independently enabled or disabled by the user. For example, the user may turn off the assignment of stories to developers by using the slider 612, while continuing to use the velocity optimizer 220 to assign sizes to different stories.

FIG. 7B is a flowchart of an example of a process 700B for assigning a developer to a story, according to aspects of the disclosure. The story may be any of the stories identified in FIG. 7A. The developer may be any of the developers identified in FIG. 7A. The process 700B may be performed for each of the stories identified in FIG. 7A. At step 732, a plurality of developers are identified who have sized the story the lowest and have sufficient capacity to work on the story. By way of example, the plurality may include 2-3 developers who have submitted the lowest bids for the story out of all developers who have submitted bid. In other words, the developers in the plurality may be fewer than all developers in a team who have submitted bids on the story. At step 734, a respective performance pattern is determined for each of the developers. At step 736, the story is assigned to the developer having the best performance pattern. At step 738, the remaining capacity of the developer to whom the story is assigned is updated by deducting the size of the story from the developer's current capacity.

In one example, the performance pattern of a developer may be determined based on the velocity of the developer. The manner in which developer velocity is calculated is discussed further below with respect to FIG. 8D. For example, if a developer has a velocity in the range 7-10, the developer may be considered to have an above_average performance pattern; if the developer has a velocity in the range 4-6, the developer may have an average performance pattern, and if the developer has a velocity in the range 1-3, the developer may have a below_average performance pattern. In some respects, the term “performance pattern” may refer to a metric of the productivity of a developer. In some implementations, the value of the performance pattern metric may be selected from the set of {below_average, average, and above_average}.

In some respects, the developers identified at step 732 may have submitted different bids. In other words, the story size submitted by one of the developers may be larger than the story size submitted by another one of the developers. Accordingly, the process 700B does not necessarily assign the story to the developer who has submitted the lowest bid. Rather, the process 700B assigns the story to a developer who has submitted one of the lowest bids (but not necessarily the lowest) and who has the best performance pattern out of all developers who have submitted the lowest bids.

FIG. 8A is a flowchart of an example of a process 800A for assigning work points to a story that is part of a sprint. At step 802, the velocity optimizer 220 identifies a team of developers who would perform a sprint that is being planned (hereinafter “current sprint”). At step 804, the velocity optimizer 220 identifies a previous sprint. In some implementations, the previous sprint may be one that is performed by the team of developers (identified at step 802). Additionally or alternatively, in some implementations, the previous sprint may be the last sprint that is performed by the team of developers (or an earlier sprint). At step 806, the velocity optimizer determines whether the current sprint has a higher performance goal than the previous sprint. The determination may be made based on user input that is provided via an input component, such as the input component 414 (shown in FIG. 4). If the current sprint has a higher performance goal, the process 800A proceeds to step 808. Otherwise, the process 800B proceeds to step 810. At step 808, the velocity optimizer 220 assigns a respective size to each story in the workload of the current sprint. The assignment is performed by executing a process 800B for each of the stories. The process 800B is discussed further below with respect to FIG. 8B. At step 810, the velocity optimizer 220 assigns a respective size to each story in the workload of the current sprint. The assignment is performed by executing a process 800C for each of the stories. The process 800C is discussed further below with respect to FIG. 8C.

FIG. 8B is a flowchart of an example of a process 800B for assigning a size to a story when the goal for a sprint of which the story is part is higher than the goal of a previous sprint.

At step 812, the velocity optimizer 220 identifies a plurality of bids that have been submitted for a story. The story may be part of the workload of the sprint. Each of the bids in the plurality may be submitted by a different developer on a team that is assigned to perform the sprint. In some implementations, the plurality of bids may include a different respective bid that is made by each of the developers on the team. Each of the bids may be made by using a user interface screen, such as screens 500A-B, which are discussed above with respect to FIGS. 5A-B.

At step 814, the velocity optimizer 220 identifies the lowest bid in the plurality. In addition, the velocity optimizer identifies the percentage of developers on the team who have submitted the lowest bid. For example, if the lowest bid in the plurality of bids is equal to 2 work points, the velocity optimizer may identify the percentage of developers on the team who have submitted 2 work points as their bid on the story.

At step 816, the velocity optimizer 220 identifies the second-lowest bid in the plurality.

At step 818, the velocity optimizer 220 identifies a developer who has made the lowest (identified at step 814). In instances in which the lowest bid has been submitted more than once by different developers, the velocity optimizer 220 may select one of the developers based on a predetermined criterion. For example, the velocity optimizer 220 may select the developer with the longest experience, etc.

At step 820, the velocity optimizer 220 identifies a velocity of the developer (identified at step 818). The velocity of the developer may be identified in the manner discussed further below with respect to FIG. 8D.

At step 822, the velocity optimizer 220 identifies a value A based on the velocity of the developer who has made the lowest bid (identified at step 820). In instances in which the velocity is a number in the range 0-1, the value A may be equal to the velocity. As another example, if the velocity is a label selected from the set “below_average”, “average”, and “above average”, the velocity optimizer may: assign A the value of 0.33 if the velocity is below_average; assign A the value of 0.66 if the velocity is average; and assign A the value of 1 if the velocity is above_average. It will be understood that the present disclosure is not limited to any specific method for mapping the velocity to the value of the value A.

At step 824, the velocity optimizer 220 identifies a value B based on the percentage of developers on the team who have submitted the lowest bid (identified at step 816). According to the present example, the value is equal to the percentage. For example, if 35% of the developers in the plurality submitted the lowest bid, B may be set to equal 0.35.

At step 826, the velocity optimizer determines whether a predetermined condition is satisfied. According to the present example, the predetermined condition is satisfied when the value A is greater than a first threshold T1 and the value of B is greater than a threshold T2. According to the present example, T1 is equal to 0.8 and T2 is equal to 0.3. However, the present disclosure is not limited to any specific value of threshold T1 and T2. If the condition is satisfied, the process 800A proceeds to step 828. Otherwise, if the condition is not satisfied, the process 800B proceeds to step 830.

At step 828, the velocity optimizer 220 assigns to the story a size that is equal to the number of work points in the lowest bid.

At step 830, the velocity optimizer 220 assigns to the story a size that is equal to the number of work points in the second-lowest bid.

FIG. 8C is a flowchart of an example of a process 800C for assigning a size to a story when the goal for a sprint of which the story is the same as the goal of a previous sprint.

At step 832, the velocity optimizer 220 identifies a plurality of bids that have been submitted for a story. The story may be part of the workload of a sprint. Each of the bids in the plurality may be submitted by a different developer in a team that is assigned to perform the sprint. In some implementations, the plurality of bids may include a different respective bid that is made by each of the developers on the team. Each of the bids may be made by using a user interface screen, such as screens 500A-B, which are discussed above with respect to FIGS. 5A-B.

At step 834, the velocity optimizer 220 identifies the second-lowest bid in the plurality. In addition, the velocity optimizer identifies the percentage of developers on the team who have submitted the second-lowest bid. For example, if the second-lowest bid in the plurality of bids is equal to 3 work points, the velocity optimizer may identify the percentage of developers on the team who have submitted 3 work points as their bid on the story.

At step 836, the velocity optimizer 220 identifies the third-lowest bid in the plurality.

At step 838, the velocity optimizer 220 identifies a developer who has made the second-lowest bid (identified at step 834). In instances in which the lowest bid has been submitted more than once by different developers, the velocity optimizer 220 may select one of the developers based on a predetermined criterion. For example, the velocity optimizer 220 may select the developer with the longest experience, etc.

At step 840, the velocity optimizer 220 identifies a velocity of the developer who has submitted the second-lowest bid (identified at step 838). The velocity of the developer may be identified in the manner discussed further below with respect to FIG. 8D.

At step 842, the velocity optimizer 220 identifies a value A based on the velocity of the developer (identified at step 840). In instances in which the velocity is a number in the range 0-1, the value A may be equal to the velocity. As another example, if the velocity is a label selected from the set “below_average”, “average”, and “above average”, the velocity optimizer may: assign A the value of 0.33 if the velocity is below_average; assign A the value of 0.66 if the velocity is average; and assign A the value of 1 if the velocity is above_average. It will be understood that the present disclosure is not limited to any specific method for mapping the velocity to the value of the value A.

At step 844, the velocity optimizer 220 identifies a value B based on the percentage of developers on the team who have submitted the second-lowest bid (identified at step 834). According to the present example, the value is equal to the percentage. For example, if 35% of the developers in the plurality submitted the second-lowest bid, B may be set to equal 0.35.

At step 846, the velocity optimizer determines whether a predetermined condition is satisfied. According to the present example, the predetermined condition is satisfied when the value A is greater than a first threshold T1 and the value of B is greater than a threshold T2. According to the present example, T1 is equal to 0.8 and T2 is equal to 0.3. However, the present disclosure is not limited to any specific value of threshold T1 and T2. If the condition is satisfied, the process 800A proceeds to step 848. Otherwise, if the condition is not satisfied, the process 800B proceeds to step 850.

At step 848, the velocity optimizer 220 assigns to the story a size that is equal to the number of work points in the second-lowest bid.

At step 850, the velocity optimizer 220 assigns to the story a size that is equal to the number of work points in the third-lowest bid.

FIG. 8D is a flowchart of an example of a process 800D for calculating developer velocity, according to aspects of the disclosure. At step 852, the velocity optimizer 220 obtains an information set that is associated with a developer. The information set may include one or more of the following information items: (i) the length of the developer's experience as a programmer, (2) the average number of work points delivered by the developer in the last 10 sprints in which the developer participated, (3) the variance in work points delivered by the developer per sprint, (4) the average number of leaves taken by the developer, (5) leave variance of the developer, (6) a measure of defects in code produced by the developer in sprints in which the developer participated, (7) availability of the developer for development work (in hours), and (8) presence of seasonal factors (e.g., presence of holidays or other factors that affect the pace of work, etc.) in a time period for which the velocity calculated. The information set may be retrieved from one or more databases, such as the database(s) 252 (shown in FIG. 2). At step 854, a signature is generated for the developer based on the information set (obtained at step 852). In some implementations, the signature may include a plurality of portions, wherein each portion encodes a different respective information item from the set (obtained at step 852). At step 856, the signature is classified with a machine learning classifier to determine a velocity of the developer. The machine learning classifier may be the same or similar to the classifier 1128, which is discussed further below with respect to FIG. 11.

FIG. 8E is a flowchart of an example of a process 800E for calculating an adaptive threshold, according to aspects of the disclosure. The adaptive threshold may be a value against which the velocity (determined in process 800D) is compared. If the velocity is above the adaptive threshold, this means that the productivity of the developer is satisfactory. However, if the adaptive threshold is below the threshold, this means that the developer's productivity is unsatisfactory. In some implementations, the adaptive threshold for the developer may be indicative of the maximum allowable variance of the number of work points that are delivered by the developer.

At step 862, the velocity optimizer 220 obtains an information set that is associated with a developer. The information set may include one or more of the following information items: (i) the length of the developer's experience as a programmer, (2) the average number work points delivered by the developer in the last 10 sprints in which the developer participated, (3) the variance in work points delivered by the developer per sprint, (4) the average number of leaves taken by the developer. (v) leave variance of the developer, (vi) a measure of defects in code produced by the developer in each of one or more sprints in which the developer participated, (vii) availability of the developer for development work (in hours), and (viii) presence of seasonal factors in a time for which the velocity calculated. At step 864, a signature is generated for the developer based on the information set (obtained at step 862). In some implementations, the signature may include a plurality of portions, wherein each portion encodes a different respective information item from the set. At step 866, the signature is classified with a machine learning classifier to calculate an adaptive threshold for the developer. The machine learning classifier may be the same or similar to classifier 1126, which is discussed further below with respect to FIG. 11.

According to aspects of the disclosure, the information set obtained at step 852 may have different information types than the information set obtained at step 862. As another example, the information set obtained at step 852 may have the same information types as the information set obtained at step 862. For instance, the information set obtained at step 852 may include a first value from a first type, a first value from a second type, and a first value from a third type, and the information set obtained at step 862 may include a second value from the first type, a second value from the second type, and a second value from the third type. The first and second values from the first type may be the same or different (e.g., when the values are different, they may be retrieved at different times). The first and second values from the second type may be the same or different (e.g., when the values are different, they may be retrieved at different times). The first and second values from the third type may be the same or different (e.g., when the values are different, they may be retrieved at different times). In other words, in some implementations, the classifiers used at steps 856 and 866 may be trained to classify the same data into different sets of categories. For example, the classifier used at step 856 may be configured to classify data into categories that correspond to respective velocity values, and the classifier used at step 866 may be configured to classify the same data into categories that correspond to respective adaptive threshold values. Additionally or alternatively, in some implementations, at least some of the items in the information set obtained at step 862 may be specific to the developer and may not apply to other developers on the team (e.g., leave variance, etc.).

FIG. 9 is a flowchart of an example of a process 900 for monitoring the performance of a team of developers, according to aspects of the disclosure.

At step 902, a first information set is obtained that is associated with a team of developers. By way of example, the first information set may include one or more of the following data items: (i) an ID of application associated with the sprint, (ii) an identifier of a developer team, (iii) an indication of average experience of the developers on the team, (iv) average work points delivered/sprint for last 10 sprints, (v) variance in the number of work points delivered per sprint/team of developers, (vi) the average number of leaves per sprint/team of developers, (v) leave variance/team of developers, (vi) an indication of the amount defects that are detected in work by the team, (vii) an indication of an organizational goal for the performance of the team, (viii) an indication of team's goal for the performance of the team, (ix) an indication of the industry average for the performance similar teams, (x) an indication of the type of time period in which the sprint would be performed, and (ix) an indication of seasonal factors. The indication of the type of period in which the sprint would be performed may indicate that the sprint would be performed in one of the following periods: before code lock, before E2E sign-off, during release, and after release. The indication of seasonal factors may indicate whether the sprint would be performed in a period in which holidays or other factors that affect the pace of work are present.

At step 904, a first signature is generated for the team based on the first information set (obtained at step 902). In some implementations, the first signature may include a plurality of portions, wherein each portion encodes a different respective information item from the first information set.

At step 906, the first signature is classified with a machine learning classifier to determine an adaptive threshold for the team. In some implementations, the adaptive threshold for the team may be indicative of the maximum allowable variance of the number of work points that are delivered by the team. The machine learning classifier may be the same or similar to the classifier 1122, which is discussed further below with respect to FIG. 11.

At step 908, a second information set is obtained that is associated with a team of developers. By way of example, the second information set may include one or more of the following data items: (i) an ID of application associated with the sprint, (ii) an identifier of a developer team, (iii) an indication of average experience of the developers on the team, (iv) average work points delivered/sprint for last 10 sprints, (v) variance in the number of work points delivered per sprint/team of developers, (vi) the average number of leaves per sprint/team of developers, (v) leave variance/team of developers, (vi) an indication of the amount defects that are detected in work by the team, (vii) an indication of an organizational goal for the performance of the team, (viii) an indication of team's goal for the performance of the team, (ix) an indication of the industry average for the performance similar teams, (x) an indication of the type of time period in which the sprint would be performed, and (ix) an indication of seasonal factors. The first information set (obtained at step 902) and the second information set (obtained at step 908) may include the same or different information types.

At step 910, a second signature is generated for the developer based on the second information set (obtained at step 908). In some implementations, the second signature may include a plurality of portions, wherein each portion encodes a different respective information item from the second information set.

At step 912, the second signature is classified with a machine learning classifier to determine a velocity of the team. The machine learning classifier may be the same or similar to the classifier 1124, which is discussed further below with respect to FIG. 11.

At step 914, the velocity optimizer 220 determines whether the team velocity (calculated at step 912) meets the adaptive threshold (calculated at step 906). The adaptive threshold is met when the team velocity indicates that the team has a lower productivity than that specified by the threshold, or when the velocity indicates that the productivity of the team is declining in a way that is suggestive that it may fall below the productivity specified by the threshold. Whether the velocity meets the threshold may be determined in the manner discussed further below with respect to step 1006 of the process 1000. For instance, whether the velocity meets the threshold may be determined based on the distance between the velocity and the threshold. The distance may be calculated by subtracting the velocity from the threshold. When the velocity is greater than the threshold, the velocity may meet the threshold if the distance between the velocity and the threshold is less than a predetermined value. Furthermore, the velocity may meet the threshold when the when the velocity is less than or equal to the threshold. However, alternative implementations are possible in which the velocity meets the adaptive threshold only when the velocity is less than the threshold. When the velocity meets the threshold, the process 1000 proceeds to step 1008.

At step 916, the velocity optimizer 220 outputs an alert that the productive output of the team is reduced. Outputting the alert may include one or more of displaying the alert on a display screen of a device, sending an email (or SMS or another type of push notification) to a manager or team leader, updating a database to indicate that the team is underperforming, and/or any other suitable action.

At step 918, the velocity optimizer 220 abstains from outputting an alert that the productive output of the team is reduced. Abstaining from the output of an alert may include terminating the process 900, executing the process 900 again, executing another task that is not associated with the process 900, or simply taking no further action.

FIG. 10 is a flowchart of an example of a process 1000, according to aspects of the disclosure. According to the present example, the process 1000 is performed by the velocity optimizer 220. However, the present disclosure is not limited to any specific entity executing the process 1000. At step 1002, the velocity optimizer 220 obtains the adaptive threshold for a developer that is assigned to work on a sprint. The adaptive threshold may be obtained in the manner discussed above with respect to FIG. 8D. At step 1004, the velocity optimizer 220 obtains velocity of the developer. The velocity of the developer may be determined in the manner discussed above with respect to FIG. 8E.

At step 1006, the velocity optimizer determines whether the velocity (calculated at step 1002) meets the adaptive threshold (calculated at step 1004). According to the present disclosure, the adaptive threshold is met when the developer velocity indicates that the developer has a lower productivity than that specified by the threshold, or when the velocity indicates that the productivity of the developer is declining in a way that is suggestive that it may fall below the productivity specified by the threshold. In some respects, the velocity crossing the threshold may indicate that the productivity of the developer has become lower than that specified by the threshold. On the other hand, if the velocity is greater than the threshold, but it exhibits a trend in which it is approaching the threshold, this may indicate that the productivity of the developer is decreasing. According to the present example, whether the velocity meets the adaptive threshold is determined based on a distance between the velocity and the adaptive threshold. The distance between the adaptive threshold may be calculated by subtracting the velocity from the adaptive threshold. A positive distance may indicate that the adaptive threshold is greater than the velocity, and a negative distance may indicate than the velocity is greater than the threshold. When the velocity is greater than the threshold, the velocity may meet the threshold if the distance between the threshold and the velocity is greater than a predetermined value. Furthermore, the velocity may meet the threshold when the when the velocity is less than or equal to the threshold. However, alternative implementations are possible in which the velocity meets the adaptive threshold only when the velocity is less than the threshold. When the velocity meets the threshold, the process 1000 proceeds to step 1008.

At step 1008, the velocity optimizer 220 outputs an alert that the productive output of a developer is reduced. Outputting the alert may include one or more of displaying the alert on a display screen of a device, sending an email to a manager or team leader, updating a database to indicate that the developer is underperforming, and/or any other suitable action. At step 1010, the velocity optimizer 220 abstains from outputting an alert that the productive output of a developer is reduced. Abstaining from the output of an alert may include one or more of terminating the execution of the process 1000, executing the process 1000 again, executing another task that is not associated with the process 1000, or simply taking no further action.

FIG. 11 is a diagram of the velocity optimizer 220, according to one implementation. As illustrated, the velocity optimizer may include an analysis and recommendation engine 1102 and a frontend 1103. The engine 1102 may be configured to execute a team threshold classifier 1122, a team velocity classifier 1124, a developer threshold classifier 1126, a developer velocity classifier 1128, a leave variance service 1116, an adaptive threshold service 1118, and a velocity signature service 1112. The analysis and recommendation engine 1102 may be configured to perform, at least in part, any of the processes discussed above with respect to FIGS. 7B-8 The frontend 1103 may include a management console 1104, a web application 1110, a velocity optimizer (VO) service 1114, an adaptive threshold notification service 1120, and web hooks 1121.

The classifier 1122 may be used to calculate an adaptive threshold for a team of developers. Specifically, the classifier 1122 may be configured to receive a signature and classify the signature into one of a plurality of categories. The signature may be the same or similar to the signature discussed above with respect to step 904 of the process 900 (shown in FIG. 9). Each of the categories in the plurality may correspond to a different adaptive threshold value. In some implementations, the classifier may implement an adaptive boosting algorithm, such as AdaBoost or XGBoost. In some implementations, the classifier may be trained by using a supervised learning algorithm based on a training dataset. The training data set may include a plurality of training items. Each training item may include a respective signature and a label corresponding to the signature. The signature of any of the training items may be the same or similar signature discussed above with respect to step 904, and the label may identify an adaptive threshold value that corresponds to the signature. The label may be specified manually by a human expert.

The classifier 1124 may be used to calculate a velocity for a team of developers. Specifically, the classifier 1124 may be configured to receive a signature and classify the signature into one of a plurality of categories. The signature may be the same or similar to the signature discussed above with respect to step 910 of the process 900 (shown in FIG. 9). Each of the categories in the plurality may correspond to a different velocity value. In some implementations, the classifier may implement an adaptive boosting algorithm, such as AdaBoost or XGBoost. In some implementations, the classifier may be trained by using a supervised learning algorithm based on a training dataset. The training data set may include a plurality of training items. Each training item may include a respective signature and a label corresponding to the signature. The signature of any of the training items may be the same or similar signature discussed above with respect to step 910, and the label may identify a velocity value that corresponds to the signature. The label may be specified manually by a human expert.

The classifier 1126 may be used to calculate an adaptive threshold for an individual developer. Specifically, the classifier 1126 may be configured to receive a signature and classify the signature into one of a plurality of categories. The signature may be the same or similar to the signature discussed above with respect to step 864 of the process 800E (shown in FIG. 8E). Each of the categories in the plurality may correspond to a different adaptive threshold value. In some implementations, the classifier may implement an adaptive boosting algorithm, such as AdaBoost or XGBoost. In some implementations, the classifier may be trained by using a supervised learning algorithm based on a training dataset. The training data set may include a plurality of training items. Each training item may include a respective signature and a label corresponding to the signature. The signature of any of the training items may be the same or similar to the signature discussed above with respect to step 864, and the label may identify an adaptive threshold value that corresponds to the signature. The label may be specified manually by a human expert.

The classifier 1128 may be used to calculate a velocity of an individual developer. Specifically, the classifier 1128 may be configured to receive a signature and classify the signature into one of a plurality of categories. The signature may be the same or similar to the signature discussed above with respect to step 854 of the process 800D (shown in FIG. 8D). Each of the categories in the plurality may correspond to a different velocity value. In some implementations, the classifier may implement an adaptive boosting algorithm, such as AdaBoost or XGBoost. In some implementations, the classifier may be trained by using a supervised learning algorithm based on a training dataset. The training data set may include a plurality of training items. Each training item may include a respective signature and a label corresponding to the signature. The signature of any of the training items may be the same or similar to the signature discussed above with respect to step 864, and the label may identify a velocity value that corresponds to the signature.

The classifier 1129 may be used to calculate a configuration score for a particular team and/or product. Specifically, the classifier 1129 may be configured to receive a signature and classify the signature into one of a plurality of categories. The signature may be the same or similar to the signature discussed above with respect to FIG. 3. In some implementations, the classifier may implement an adaptive boosting algorithm, such as AdaBoost or XGBoost. In some implementations, the classifier may be trained by using a supervised learning algorithm based on a training dataset. The training data set may include a plurality of training items. Each training item may include a respective signature and a label corresponding to the signature. The signature of any of the training items may be the same or similar to the signature discussed above with respect to FIG. 3, and the label may identify a configuration score value that corresponds to the signature.

In some respects, the velocity optimizer 220 may may also learn the various unique configurations/characteristics provided by development managers, form its initial model and improve it over time by continuously comparing the success rates in correlation with the various characteristics. It will assign a score to all unique paraments/settings/characters in the following ways:

| | Score |
|---|---|
| Parameters | (1-10; 1 = very bad, 10 = very good) |
| θ₁, θ₂, θ₃, θ₄ | 1 |
| θ₉, θ₁₇ | 7 |
| θ₁₈, θ₅, θ₆, θ₇, θ₈, θ₂₄ | 2 |
| θ₁₀, θ₁₁, θ₁₂, θ₁₃, θ₁₄, θ₁₅, θ₁₆ | 8 |

In the above table, θ₁-θ₁₈ represents various kinds of settings/parameters in which the velocity optimizer 220 may be used over a period to compute the signature that is being classified by any of classifiers 1122-1129. The velocity optimizer 220 may keep updating this information on a continuous basis and this is how it will create the signatures for the different development teams and individual members. The velocity optimizer may determine the success scores by using any linear regression ML techniques. This success scores may be presented to the development manager as a guidance when he/she changes/sets the parameters on which they like to enable Velocity Optimizer option to ensure optimal velocity for the business unit/organization/product lines/products for that given point in time.

The web hooks 1121 may be configured to publish events associated with the operation of the velocity optimizer 220. The events may be published on a project management software and they may include assigning a story to a developer, set/update size of a story, completed work events, remaining work events, and changes to a story status, etc. In some implementations, the project management software may provide APIs to access the details of software features, stories or defects and/or any other suitable information concerning a developer, a team of developers, or any software projects associated with the team of developers or individual developers on the team. In some implementations, the project management software may be used to provide the information necessary for training the classifiers 1122-1129 as well as for generating the signatures that are classified by the classifiers 1122-1129.

The VO service 1114 may be configured to provide APIs to access a developer team's setup data at the team level and team member level. In addition, the VO service 1114 may be configured to provide APIs to access adaptive performance thresholds and leave variance per developer and team level. In addition, the VO service 1114 may provide APIs that for recommending an optimal story size.

The adaptive threshold notification service 1120 may be configured to subscribe to the web hooks 1121, validate data in the event against VO data and publish messages to an adaptive threshold message queue.

The adaptive threshold service 1118 may be configured to execute any of the classifiers 1122-1129. It subscribes to a message queue to continuously receive updates and fine-tune the threshold for each developer. Additionally or alternatively, the adaptive threshold service may be configured to provide APIs to access the adaptive threshold score for a given developer. Additionally or alternatively, the adaptive threshold service may be configured to collect and store information about different developers. In some implementations, the adaptive threshold service 1118 may receive the ID of a developer. Next, the service 1118 may retrieve information associated with a project that corresponds to the developer. The information may include Business Key Performance Indicator (KPI) maturity ratings, Deployment KPI maturity ratings, Quality KPI maturity ratings. Next the adaptive threshold service 1118 may re-train any of the classifiers 1122-1128 based on the received information. Next, the adaptive threshold service 1118 may save the re-trained model in a database that maps the trained model to the ID of the developer. And finally, the adaptive threshold service 1118 may compute updated statistics for the developer and store the updated statistics in a database. By way of example, the updated statistics may include a moving average of the work points delivered by the developer, a percent change in the work points delivered by the developer between the last sprint the developer was involved in a previous sprint, and the work points delivered by the developer in the last sprint in which the developer participated.

The leave variance service 1116 may be configured to access the leave variance scores for a given developer. The velocity signature service 1112 may be configured to subscribe to a velocity signature message queue to receive any updates on a particular developer team. When a message containing updated information regarding a particular development team is received, the velocity signature service 1112 may be configured to retrain any of the classifiers 1122 and 1124, and/or recalculate the velocity and velocity threshold for the team. In addition, the velocity signature service 1112 may be configured retrain any of the classifiers 1126 and/or 1128 and/or recalculate the individual velocity for each (or at least) one of the developers on the team.

The web application 1110 may be configured to provide the user interface of the velocity optimizer 220 to provide sizing, to review system determined assignments, and to override assignments, if needed. In some implementations, the web application 1110 may provide the user interface screens that are discussed above with respect to FIGS. 3-7A.

The management console 1104 may provide an interface for administering the velocity optimizer 220. In addition, the management console may be configured to turn the velocity optimizer 220 on an off based on information related to any specific organization, development team, development team's maturity, time intervals and any other classifications that may be relevant to the business unit. Over time, through machine learning, the system will recommend to the organization or the business unit, which parameter(s) will yield maximum Velocity for a given org/product lines/products.

FIGS. 1-11 are provided as an example only. At least some of the steps discussed with respect to FIGS. 1-11 can be performed in a different order, concurrently, or altogether omitted.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method comprising:
calculating a velocity threshold for an entity, the entity including an individual worker or a team of workers;
calculating a velocity for the entity by classifying a first signature corresponding to the entity with a first machine learning (M/L) classifier, the velocity being a metric that measures a current productivity of the entity;
detecting whether the velocity meets the velocity threshold; and
outputting an alert when the velocity meets the velocity threshold.

2. The method of claim 1, wherein the entity includes a worker, and the first signature is generated based one or more of a length of an experience of the worker, an average number of work points delivered by the worker over a plurality of sprints, variance in the work points delivered by the worker, an average number of leaves taken by the worker in a past time period, and variance of the leaves taken by the worker.

3. The method of claim 1, wherein the entity includes a team of workers, and the first signature is generated based one or more of a length of average experience of the workers on the team, an average number of work points delivered by the team over a plurality of sprints, variance in the work points delivered by the team, an industry average for a number of work points that are delivered by the team, an average number of leaves taken by workers on the team in a past time period, and an organizational goal.

4. The method of claim 1, further comprising calculating the velocity threshold by classifying a second signature corresponding to the entity with a second M/L classifier.

5. The method of claim 1, wherein the entity includes a worker, the method further comprising assigning a story to the worker based on the velocity of the worker.

6. The method of claim 5, further comprising assigning a size to the story based on size bid for the story that is submitted by the worker.

7. The method of claim 1, wherein the entity includes a team of workers, the method further comprising:
calculating a configuration score for the team by classifying a second signature with a second M/L classifier, the second signature identifying one or more of a characteristic of the team and a characteristic of a product that is associated with one or more stories; and
outputting, based on the configuration score, a recommendation of whether to use the velocity optimizer to assign the one or more stories to workers in the team and/or assign respective sizes to the one or more stories.

8. A system comprising:
a memory; and
at least one processor operatively coupled to the memory, the at least one processor being configured to perform the operations of:
calculating a velocity threshold for an entity, the entity including an individual worker or a team of workers;
calculating a velocity for the entity by classifying a first signature corresponding to the entity with a first machine learning (M/L) classifier, the velocity being a metric that measures a current productivity of the entity;
detecting whether the velocity meets the velocity threshold; and
outputting an alert when the velocity meets the velocity threshold.

9. The system of claim 8, wherein the entity includes a worker, and the first signature is generated based one or more of a length of an experience of the worker, an average number of work points delivered by the worker over a plurality of sprints, variance in the work points delivered by the worker, an average number of leaves taken by the worker in a past time period, and variance of the leaves taken by the worker.

10. The system of claim 8, wherein the entity includes a team of workers, and the first signature is generated based one or more of a length of average experience of the workers on the team, an average number of work points delivered by the team over a plurality of sprints, variance in the work points delivered by the team, an industry average for a number of work points that are delivered by the team, an average number of leaves taken by workers on the team in a past time period, and an organizational goal.

11. The system of claim 8, further comprising calculating the velocity threshold by classifying a second signature corresponding to the entity with a second M/L classifier.

12. The system of claim 8, wherein the entity includes a worker, and the at least one processor is further configured to perform the operation of assigning a story to the worker based on the velocity of the worker.

13. The system of claim 12, wherein the at least one processor is further configured to perform the operation of comprising assigning a size to the story based on size bid for the story that is submitted by the worker.

14. The system of claim 8, wherein the entity includes a team of workers, the at least one processor is further configured to perform the operations of:
calculating a configuration score for the team by classifying a second signature with a second M/L classifier, the second signature identifying one or more of a characteristic of the team and a characteristic of a product that is associated with one or more stories; and
outputting, based on the configuration score, a recommendation of whether to use the velocity optimizer to assign the one or more stories to workers in the team and/or assign respective sizes to the one or more stories.

15. A non-transitory computer-readable medium storing one or more processor-executable instructions, which, when executed by at least one processor, cause the at least one processor to perform the operations of:
calculating a velocity threshold for an entity, the entity including an individual worker or a team of workers;
calculating a velocity for the entity by classifying a first signature corresponding to the entity with a first machine learning (M/L) classifier, the velocity being a metric that measures a current productivity of the entity;
detecting whether the velocity meets the velocity threshold; and
outputting an alert when the velocity meets the velocity threshold.

16. The non-transitory computer-readable medium of claim 15, wherein the entity includes a worker, and the first signature is generated based one or more of a length of an experience of the worker, an average number of work points delivered by the worker over a plurality of sprints, variance in the work points delivered by the worker, an average number of leaves taken by the worker in a past time period, and variance of the leaves taken by the worker.

17. The non-transitory computer-readable medium of claim 15, wherein the entity includes a team of workers, and the first signature is generated based one or more of a length of average experience of the workers on the team, an average number of work points delivered by the team over a plurality of sprints, variance in the work points delivered by the team, an industry average for a number of work points that are delivered by the team, an average number of leaves taken by workers on the team in a past time period, and an organizational goal.

18. The non-transitory computer-readable medium of claim 15, further comprising calculating the velocity threshold by classifying a second signature corresponding to the entity with a second M/L classifier.

19. The non-transitory computer-readable medium of claim 15, wherein the entity includes a worker, and the processor-executable instructions, when executed by the at least one processor, further cause the at least one processor to perform the operation of comprising assigning a story to the worker based on the velocity of the worker.

20. The non-transitory computer-readable medium of claim 19, wherein the processor-executable instructions, when executed by the at least one processor, further cause the at least one processor to perform the operation of assigning a size to the story based on size bid for the story that is submitted by the worker.
